(19) United States
(12) Patent Application Publication
(10) Pub. No.: US 2019/0381858 A1
(43) Pub. Date: Dec. 19, 2019

(54) FLUID COUPLER FOR A DUCT ASSEMBLY

(71) Applicant: GM GLOBAL TECHNOLOGY OPERATIONS LLC, DETROIT, MI (US)

(72) Inventors: Matt Sadowski, Lake Orion, MI (US); Darren P. MILES, Rochester, MI (US)

(21) Appl. No.: 16/010,702

(22) Filed: Jun. 18, 2018

(51) Int. Cl. B60H 1/00

(52) U.S. Cl. CPC B60H 1/00285; B60N 2/02; B60H 1/00564

(57) ABSTRACT

A duct assembly includes a first rigid duct member having a first face with a first opening therethrough and a first plate slidably coupled to the first face. A long dimension of the first plate exceeds a long dimension of the first opening. The first plate is provided with a first orifice therethrough. The assembly additionally includes a second rigid duct member having a second face with a second opening therethrough and a second plate slidably coupled to the second face. A long dimension of the second plate exceeds a long dimension of the second opening. The second plate is provided with a second orifice therethrough. The assembly additionally includes a rotatable coupler member fluidly coupling the first orifice to the orifice. The rotatable coupler is configured to accommodate relative rotation between the first rigid duct member and the second rigid duct member.

### TECHNICAL FIELD

The present disclosure relates to a fluid coupling assembly for ducts, and more specifically to a fluid coupling assembly for a climate control system for an automotive vehicle.

### INTRODUCTION

Automotive HVAC systems are well known and are utilized for heating and cooling the passenger compartments of vehicles. Such HVAC systems are provided with a plurality of duct assemblies for carrying heated or cooled air from the engine compartment to vents disposed at various locations within the passenger compartment. To provide heating or cooling to front seats in the passenger compartment, a plurality of such vents is typically arranged in a front dash of the vehicles. To provide heating or cooling to aft rows of seats, vents are typically arranged on an aft portion of a center console disposed between the front seats.

### SUMMARY

A duct assembly according to the present disclosure includes a first rigid duct member having a first face with a first opening therethrough and a first plate slidably coupled to the first face. A long dimension of the first plate exceeds a long dimension of the first opening. The first plate is provided with a first orifice therethrough. The assembly additionally includes a second rigid duct member having a second face with a second opening therethrough and a second plate slidably coupled to the second face. A long dimension of the second plate exceeds a long dimension of the second opening. The second plate is provided with a second orifice therethrough. The assembly additionally includes a rotatable coupler member fluidly coupling the first orifice to the second orifice. The rotatable coupler is configured to accommodate relative rotation between the first rigid duct member and the second rigid duct member.

In an exemplary embodiment, the assembly additionally includes a first tubular coupler member coupled to the first plate and in communication with the first orifice and a second tubular coupler member coupled to the second plate and in communication with the second orifice. The rotatable coupler member comprises a cylindrical body rotatably coupling the first tubular coupler member to the second tubular coupler member.

In an exemplary embodiment, the assembly additionally includes a vent assembly fluidly coupled to the second rigid duct member.

In an exemplary embodiment, the assembly additionally includes an automotive vehicle having an occupant cabin with an articulated seat disposed therein. The first rigid duct member is fixedly coupled to the body and, the second rigid duct member is fixedly coupled to the seat.

In an exemplary embodiment, the first rigid duct member has a long axis. The first face extends generally parallel to the long axis and is provided with a track extending generally parallel to the long axis. The first plate is slidably retained in the track and slidable in a direction generally parallel to the long axis. Such embodiments may additionally include a seal disposed in the track.

An automotive vehicle according to the present disclosure includes a body having an occupant cabin and a seat disposed in the cabin. The vehicle additionally includes an actuator coupled to the seat and configured to translate or pivot the seat among a plurality of positions relative to the body. The vehicle further includes a first duct member fixedly coupled to the body. The first duct member has an inlet and a first plurality of sidewalls. A first respective sidewall of the first plurality of sidewalls has a first opening extending therethrough. A first plate is slidably coupled to the first duct member. The first plate is configured to cover a portion of the first opening and is provided with a first orifice extending therethrough. The vehicle also includes a second duct member fixedly coupled to the seat. The second duct member has an outlet and a second plurality of sidewalls. A second respective sidewall of the second plurality of sidewalls has a second opening therethrough. A second plate is slidably coupled to the second duct member. The second plate is configured to cover a portion of the second opening. The second plate is provided with a second orifice extending therethrough. The vehicle further includes a rotatable coupler member fluidly coupling the first orifice to the second orifice. The rotatable coupler is configured to accommodate relative rotation between the first duct member and the second duct member while maintaining fluid communication between the inlet and the outlet.

In an exemplary embodiment, the vehicle additionally includes a first tubular coupler member coupled to the first plate and in communication with the first orifice and a second tubular coupler member coupled to the second plate and in communication with the second orifice. The rotatable coupler member comprises a cylindrical body rotatably coupling the first tubular coupler member to the second tubular coupler member. Such embodiments may also include a first collar securing the first tubular coupler member to the first plate and a second collar securing the second tubular coupler member to the second plate.

In an exemplary embodiment, the seat has a fore side and an aft side. A vent is disposed on the aft side, with the vent being in fluid communication with the outlet.

In an exemplary embodiment, the first respective sidewall is provided with a track, with the first plate being slidably retained in the track. Such embodiments may additionally include a seal disposed in the track.

Embodiments according to the present disclosure provide a number of advantages. For example, the present disclosure provides a system for routing fluid between components with multi-axis relative motion therebetween, and moreover does so via a passive mechanism without requiring active actuation.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is an isometric view of a vehicle and duct assembly according to an embodiment of the present disclosure;

FIG. 2 is an exploded isometric view of a first duct component according to an embodiment of the present disclosure;

FIG. 3 is an isometric view of the first duct component according to an embodiment of the present disclosure;

FIG. 4 is an isometric view of a second duct component according to an embodiment of the present disclosure;

FIG. 5 is an isometric view of a duct assembly according to an embodiment of the present disclosure;

FIG. 6 is a cross-section view of a duct assembly taken along section 6-6 in FIG. 5,

FIG. 7 is a side view of a vehicle and duct assembly according to an embodiment of the present disclosure, and

FIG. 8 is a front view of a vehicle and duct assembly according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As discussed above, in automotive vehicles vents are typically arranged on an aft portion of a center console disposed between the front seats to provide heating or cooling to aft rows of seats. It may be desirable to provide vents on aft portions of the front seats for stylistic or functional reasons. However, in many automotive vehicles the front seats are articulated. Such articulated seats may provide adjustability across a plurality of axes, e.g. fore-aft translation, up-down translation, and fore-aft pitch. Known duct assemblies may be unable to accommodate the range of motion of which articulated seats are capable.

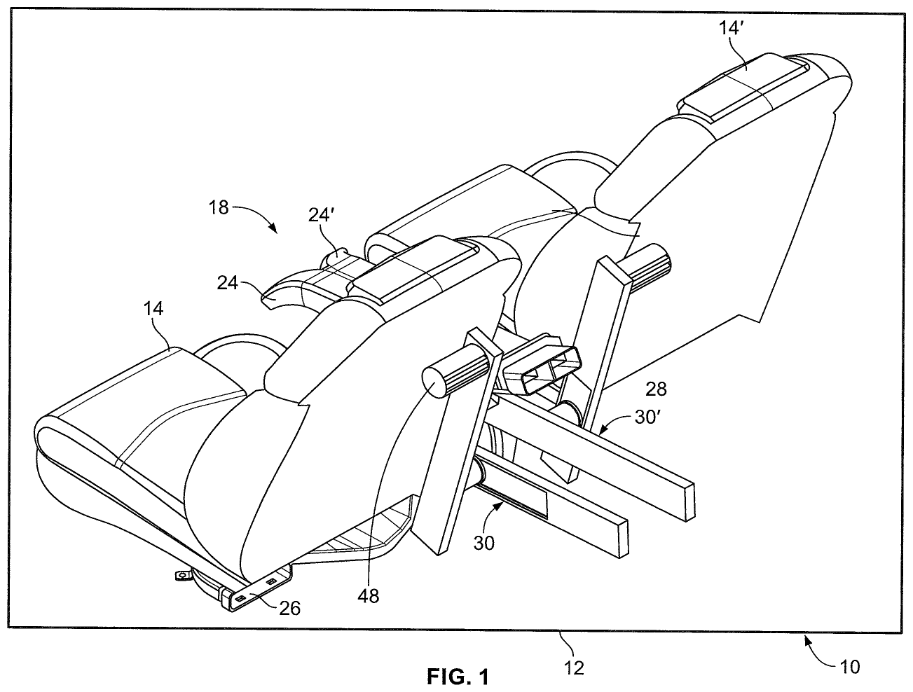

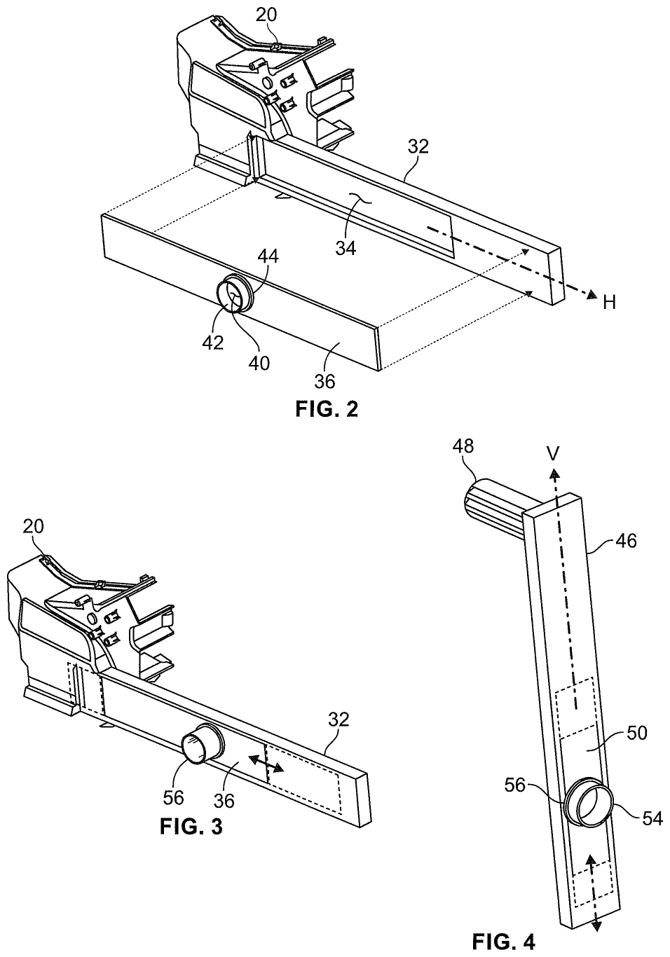

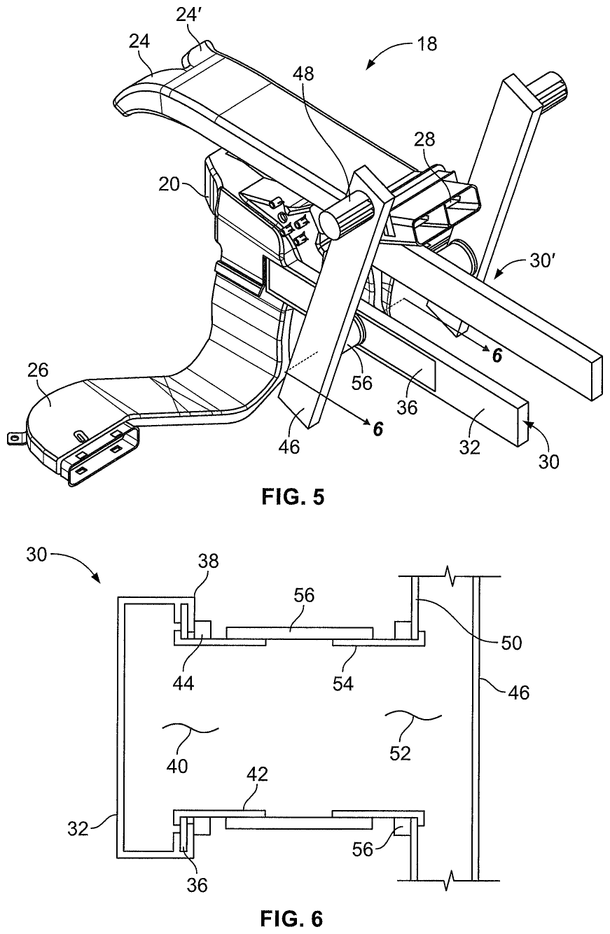

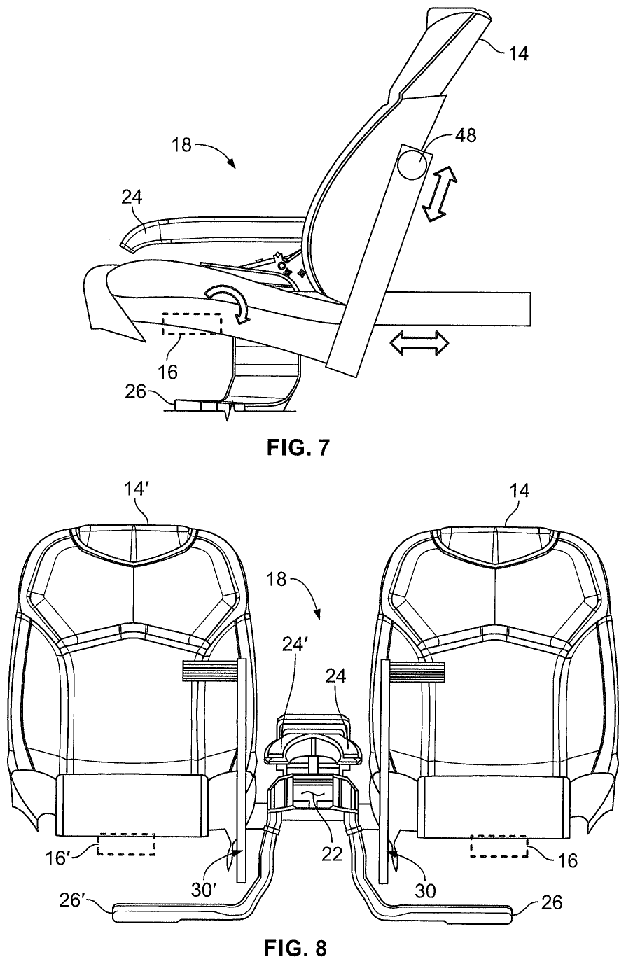

Referring now to FIGS. 1 through 8, an automotive vehicle and a duct assembly therefor according to the present disclosure is illustrated in various views. As shown in FIG. 1, an automotive vehicle 10 includes a vehicle cabin 12 provided with a front driver seat 14 and a front passenger seat 14′ (collectively, “front seats”). The vehicle cabin 12 is additionally provided with a second row of seats (not illustrated) positioned aft of the front seats 14, 14′. The front seats 14, 14′ are provided with respective actuators 16, 16′ configured to actuate the front seats 14, 14′ among a plurality of distinct positions relative to the cabin 12. In an exemplary embodiment, the actuators 16, 16′ are configured to actuate the front seats 14, 14′ in a fore-aft direction, an up-down direction, and in a fore-aft pitching direction, as depicted in FIG. 7.

The automotive vehicle 10 includes a duct assembly 18 configured to convey heating or cooling air to various regions of the vehicle cabin 12. The duct assembly 18 includes a plenum 20 disposed between the front seats 14, 14′. In an exemplary embodiment, the plenum 20 may be disposed within a center console located between the front seats 14, 14′. The plenum 20 is fluidly coupled to a heating or cooling source via a plenum inlet duct 22, e.g. to an outlet of a heating and/or air conditioning unit of the vehicle 10. The plenum 20 is configured to distribute heating or cooling air to a plurality of ducts, e.g. first duct portions 24, 24′ to convey air to floor regions of the front seats 14, 14′, second duct portions 26, 26′ to convey air to a floor region of the second row of seats, and a third duct portion 28 to convey air to a central region of the second row of seats.

The plenum 20 is also coupled to articulated duct assemblies 30, 30′. The articulated duct assembly 30 will now be discussed in greater detail; it should be understood that the articulated duct assembly 30′ may be configured in a generally similar fashion, e.g. as a mirror image of the articulated duct assembly 30.

The articulated duct assembly 30 includes a horizontal air box 32. The horizontal air box 32 is an elongate duct member which is fixed in position relative to the cabin 12, e.g. fixedly coupled to the plenum 20. The horizontal air box 32 extends along an axis H from a proximal end, fluidly coupled to the plenum 20, to a close-ended distal end. In the illustrated embodiment, the axis H extends generally horizontally in a fore-aft direction of the vehicle 10. The horizontal air box 32 is defined by a plurality of sidewalls extending generally parallel to the axis H and by an endwall at the distal end. One sidewall is provided with an opening 34 therethrough.

A sliding horizontal cover plate 36 is disposed within the horizontal air box 32 and positioned generally in register with the opening 34. The horizontal cover plate 36 is configured to slide relative to the horizontal air box 32, generally along the axis H. A length of the horizontal cover plate 36 in the direction of the axis H exceeds a length of the opening 34 in the direction of axis H, such that the horizontal cover plate 36 extends past the periphery of the opening 34. In the illustrated embodiment, the cover plate 36 is a generally planar plate; however, in other embodiments the cover plate 36 may take other shapes, e.g. an arcuate segment.

In the exemplary embodiment illustrated in FIG. 6, the horizontal air box 32 is provided with a track 38 proximate the opening 34 within which the horizontal cover plate 36 may slide. A seal, e.g. a felt material or a lubricated seal, may be provided at the interface between the track 38 and the horizontal cover plate 36. Fluid may thereby be inhibited from leaking between the horizontal air box 32 and the horizontal cover plate 36. It will be appreciated that in other embodiments within the scope of the present disclosure, the sliding interface may be defined by any conventional means known in the art.

The horizontal cover plate 36 is provided with a first orifice or aperture 40 extending therethrough. A first flanged coupler 42 is coupled to the first aperture 40 and extends away from the horizontal air box 32. A first collar 44 is provided to secure the first flanged coupler 42 to the horizontal cover plate 36. The first coupler 42 may thereby function as a movable outlet for the horizontal air box 32.

The articulated duct assembly 30 additionally includes a vertical air box 46. The vertical air box 46 is an elongate duct member which is fixed in position relative to the front seat 14, e.g. fixedly coupled to an interior structure of the front seat 14. The vertical air box 46 extends along an axis V from a close-ended proximal end to a distal end. In the illustrated embodiment, the axis V extends generally vertically in an up-down direction of the vehicle 10. The vertical air box 46 is defined by a plurality of sidewalls extending generally parallel to the axis V and by an endwall at the proximal end. One sidewall is provided with an opening therethrough in a generally similar fashion to the opening 34 in the horizontal air box 32.

A vent 48 is provided proximate the distal end of the vertical air box 46. In the illustrated embodiment the vent 48 extends from a sidewall of the vertical air box 46 at the distal end; however, in various other embodiments the vent 48 may be positioned otherwise, e.g. coupled to the distal end of the vertical air box 46.

A sliding vertical cover plate 50 is disposed within the vertical air box 46 in a generally similar fashion to the horizontal cover plate 36 in the horizontal air box 32, e.g. via a sliding interface in the sidewall opening. The vertical cover plate 50 is configured to slide relative to the vertical air box 46, generally along the axis V. The vertical cover plate 50 is provided with a second aperture 52 extending therethrough. A second flanged coupler 54 is coupled to the second aperture 52 and extends away from the vertical air box 46. A second collar 56 is provided to secure the second flanged coupler 54 to the vertical cover plate 50. The second coupler 54 may thereby function as a movable outlet for the vertical air box 46.

A third coupler 58 fluidly couples the first coupler 42 to the second coupler 54 while permitting relative rotation therebetween. In the illustrated embodiment, the third coupler 58 comprises a generally cylindrical body within which the first coupler 42 and/or second coupler 54 may pivot; however, in other embodiments contemplated by the present disclosure, other types of coupler assemblies may be used.

It will be appreciated that as the actuator 16 moves the front seat 14 relative to the cabin 12, the vertical air box 46 will likewise move relative to the horizontal air box 32. As such motion occurs, the articulated duct assembly 30 may accommodate such motion while maintaining fluid communication between the plenum 20 and the vent 48. In response to horizontal actuation of the front seat 14 relative to the cabin 12, the horizontal cover plate 36 may slide relative to the horizontal air box 32. In response to vertical actuation of the front seat 14 relative to the cabin 12, the vertical cover plate 50 may slide relative to the vertical air box 46. In response to pitching actuation of the front seat 14 relative to the cabin 12, the second coupler 54 may pivot relative to the first coupler 42.

In some embodiments, the vertical air box 46 may be fluidly coupled to a seat cooling vent for cooling the front seat 14, in addition to or instead of the vent 48. In such embodiments, the front seat 14 may be cooled without necessitating a discrete chiller unit.

As will be appreciated by those skilled in the art, similar articulated duct assemblies may be used in other embodiments to provide flexible fluid coupling of multiple components with relative motion therebetween.

As may be seen the present disclosure provides a system for routing fluid between components with multi-axis relative motion therebetween, and moreover does so via a passive mechanism without requiring active actuation.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A duct assembly comprising:
a first rigid duct member having a first face with a first opening therethrough;
a first plate slidably coupled to the first face, a long dimension of the first plate exceeding a long dimension of the first opening, the first plate being provided with a first orifice therethrough;
a second rigid duct member having a second face with a second opening therethrough;
a second plate slidably coupled to the second face, a long dimension of the second plate exceeding a long dimension of the second opening, the second plate being provided with a second orifice therethrough; and
a rotatable coupler member fluidly coupling the first orifice to the second orifice, the rotatable coupler being configured to accommodate relative rotation between the first rigid duct member and the second rigid duct member.

2. The duct assembly of claim 1, further comprising a first tubular coupler member coupled to the first plate and in communication with the first orifice and a second tubular coupler member coupled to the second plate and in communication with the second orifice, wherein the rotatable coupler member comprises a cylindrical body rotatably coupling the first tubular coupler member to the second tubular coupler member.

3. The duct assembly of claim 1, further comprising a vent assembly fluidly coupled to the second rigid duct member.

4. The duct assembly of claim 1, further comprising an automotive vehicle having an occupant cabin with an articulated seat disposed therein, the first rigid duct member being fixedly coupled to the cabin, the second rigid duct member being fixedly coupled to the seat.

5. The duct assembly of claim 1, wherein the first rigid duct member has a long axis, the first face extending generally parallel to the long axis and being provided with a track extending generally parallel to the long axis, the first plate being slidably retained in the track and slidable in a direction generally parallel to the long axis.

6. The duct assembly of claim 5, further comprising a seal disposed in the track.

7. An automotive vehicle comprising:
a body having an occupant cabin;
a seat disposed in the cabin;
an actuator coupled to the seat and configured to translate or pivot the seat among a plurality of positions relative to the body;
a first duct member fixedly coupled to the body, the first duct member having an inlet and a first plurality of sidewalls, a first respective sidewall of the first plurality of sidewalls having a first opening extending therethrough;
a first plate slidably coupled to the first duct member, the first plate being configured to cover a portion of the first opening, the first plate being provided with a first orifice extending therethrough;
a second duct member fixedly coupled to the seat, the second duct member having an outlet and a second plurality of sidewalls, a second respective sidewall of the second plurality of sidewalls having a second opening therethrough;
a second plate slidably coupled to the second duct member, the second plate being configured to cover a portion of the second opening, the second plate being provided with a second orifice extending therethrough; and
a rotatable coupler member fluidly coupling the first orifice to the second orifice, the rotatable coupler being configured to accommodate relative rotation between the first duct member and the second duct member while maintaining fluid communication between the inlet and the outlet.

8. The automotive vehicle of claim 7, further comprising a first tubular coupler member coupled to the first plate and in communication with the first orifice and a second tubular coupler member coupled to the second plate and in communication with the second orifice, wherein the rotatable coupler member comprises a cylindrical body rotatably coupling the first tubular coupler member to the second tubular coupler member.

9. The automotive vehicle of claim 8, further comprising a first collar securing the first tubular coupler member to the first plate and a second collar securing the second tubular coupler member to the second plate.

10. The automotive vehicle of claim 7, wherein the seat has a fore side and an aft side, further comprising a vent disposed on the aft side, the vent being in fluid communication with the outlet.

11. The automotive vehicle of claim 7, wherein the first respective sidewall is provided with a track, the first plate being slidably retained in the track.

12. The automotive vehicle of claim 11, further comprising a seal disposed in the track.
